(19) United States
(12) Patent Application Publication
(10) Pub. No.: US 2019/0309899 A1
(43) Pub. Date: Oct. 10, 2019

(54) I-BEAM STORAGE BRACKET SYSTEM

(71) Applicant: Roy Duarte, Kitchner (CA)

(72) Inventor: Roy Duarte, Kitchner (CA)

(21) Appl. No.: 16/378,893

(22) Filed: Apr. 9, 2019

Related U.S. Application Data
(60) Provisional application No. 62/654,902, filed on Apr. 9, 2018.

(51) Int. Cl. F16M 13/02; F16B 2/10; F16B 45/00

(52) U.S. Cl. CPC F16M 13/022; F16M 13/027; F16B 45/00; F16B 2/10

(57) ABSTRACT

The present invention is a bracket system constructed and arranged to provide an I-beam storage system.

This application is a non-provisional of, and claims benefit to, U.S. Provisional Patent Application Ser. No. 62/654,902 filed Apr. 9, 2018 the disclosure which is incorporated herein by reference in its entirety.

### BACKGROUND OF THE INVENTION

Exposed beams are common in many structures. Garage and storage rooms often have exposed beams. Additionally, exposed beams are often utilized in various aspects of interior design. A difficulty has always been utilization of storage above and around these beams. Storage systems are often difficult to install.

The present invention addresses this difficulty.

### SUMMARY OF THE INVENTION

A simple to install system is provided whereby a tab is constructed to contact an I-beam as shown herein. The tab is fastened into position and utilized for storage.

In one embodiment, the invention is a storage system comprising:
a main support bracket, said bracket constructed and arranged to connect and mate directly to a beam;
a securing plate having one or more fastening cavities; and
a locking bolt.

In one embodiment, the support bracket has u-shaped first mounting end constructed to mate with an I-beam.

In one embodiment, the support bracket is constructed to receive and connect with said securing plate.

In one embodiment, the system is utilizing a single support bracket.

In one embodiment, the system is utilizing two support brackets imparting a linear configuration affixed to a single main support bracket.

In one embodiment, the support bracket has a second end configured with a retainment section adjacent to said second end.

In one embodiment, the support bracket has a second end configured with a retainment section adjacent to said second end said retainment section configured with an upward angle of 10-30 degrees relative to a horizontal created by support bracket.

In one embodiment, the invention is a storage system consisting essentially of:

a main support bracket, said bracket constructed and arranged to connect and mate directly to an I-beam wherein said bracket u-shaped first mounting end constructed to mate with said I-beam and a second end configured as a retainment section configured with an upward angle of 10-30 degrees relative to a horizontal created by support bracket;
a securing plate having one or more fastening cavities; and
a locking bolt.

### BRIEF DESCRIPTION OF THE SEVERAL VIEWS OF THE DRAWAINGS

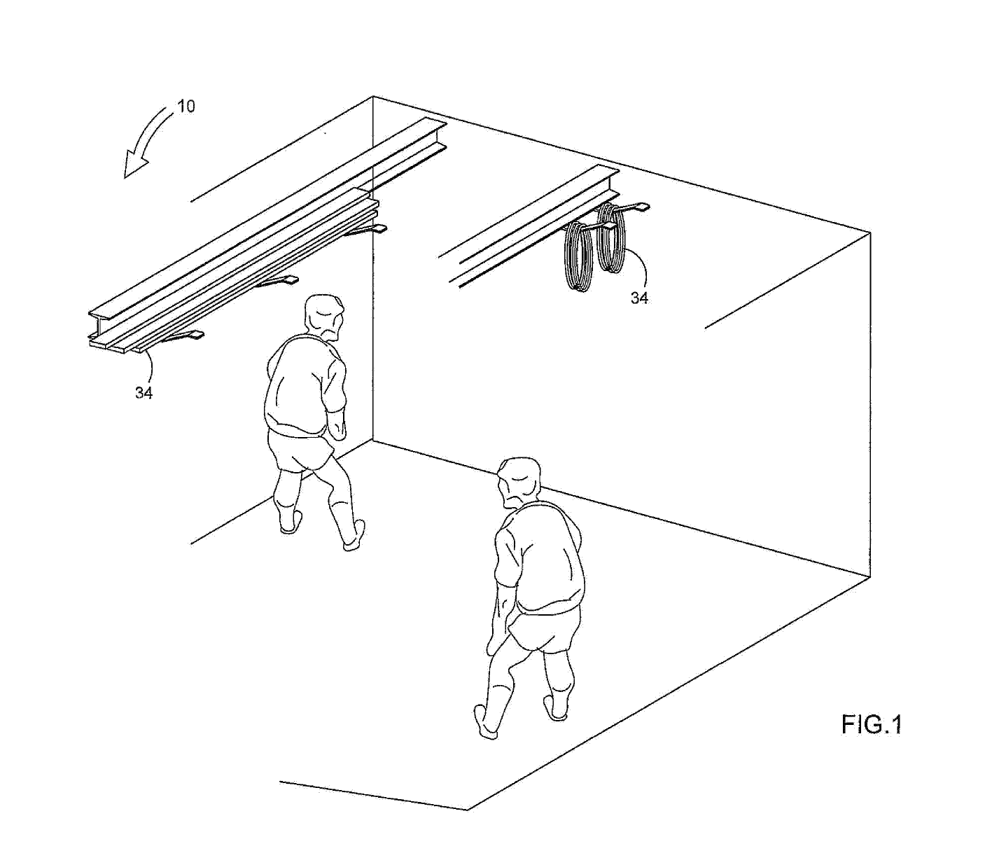

FIG. 1 shows a material storage bracket system according to one embodiment of the present invention.

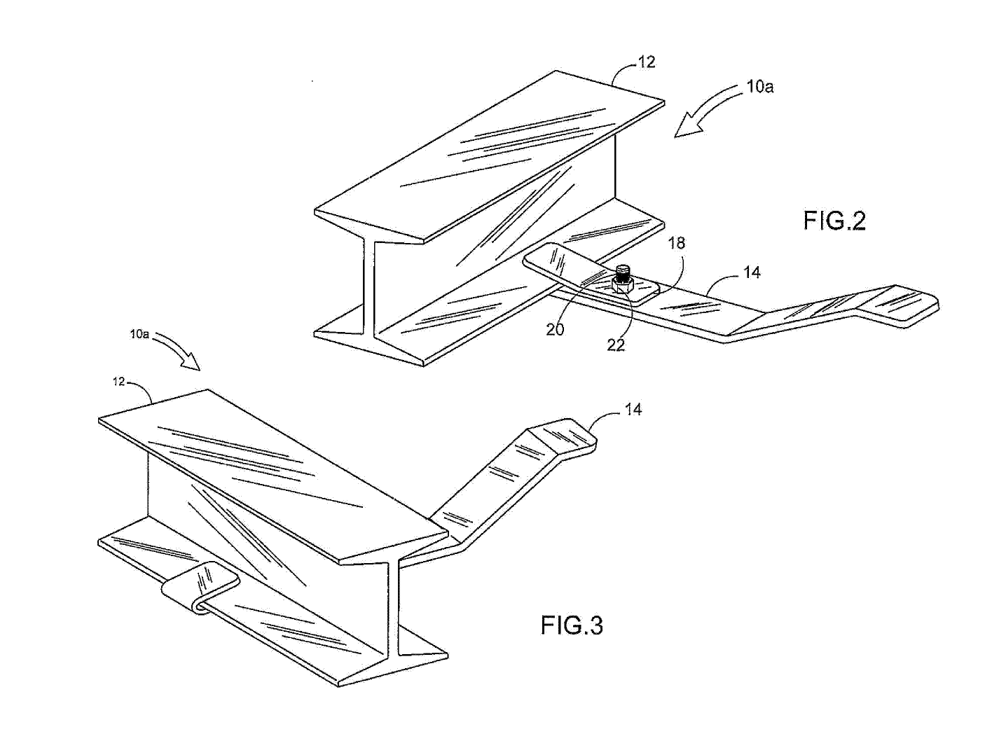

FIG. 2 is a side perspective view of a bracket according to one embodiment of the present invention.

FIG. 3 is a side perspective view of a bracket according to one embodiment of the present invention.

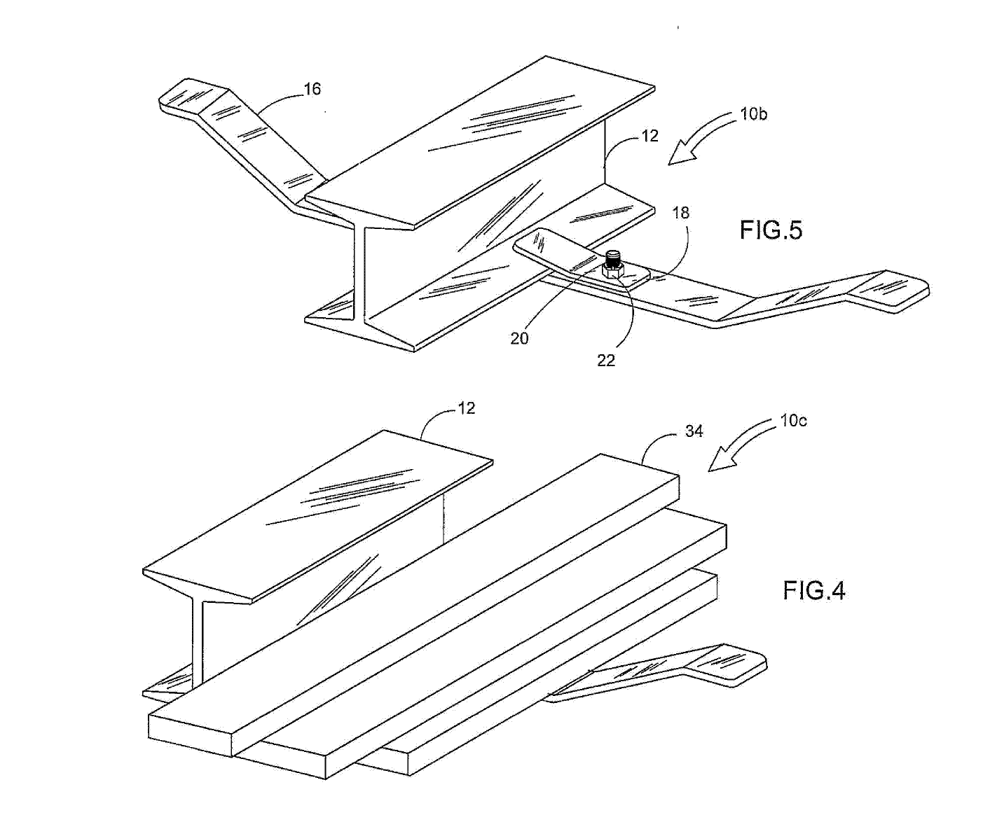

FIG. 4 shows a dual side storage bracket system indicating placement of storage material according to one embodiment of the present invention.

FIG. 5 shows a dual side storage bracket system according to one embodiment of the present invention.

FIG. 6 is a top view of a storage bracket according to one embodiment of the present invention.

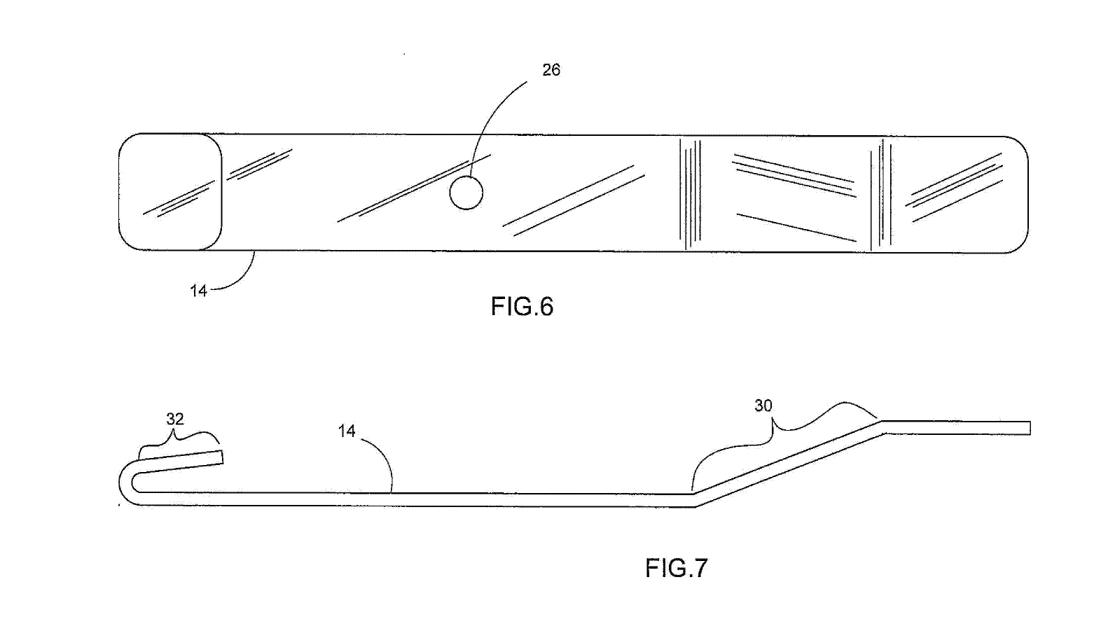

FIG. 7 is a side view of a storage bracket according to one embodiment of the present invention.

FIG. 8 is a top view of a securing plate according to one embodiment of the present invention.

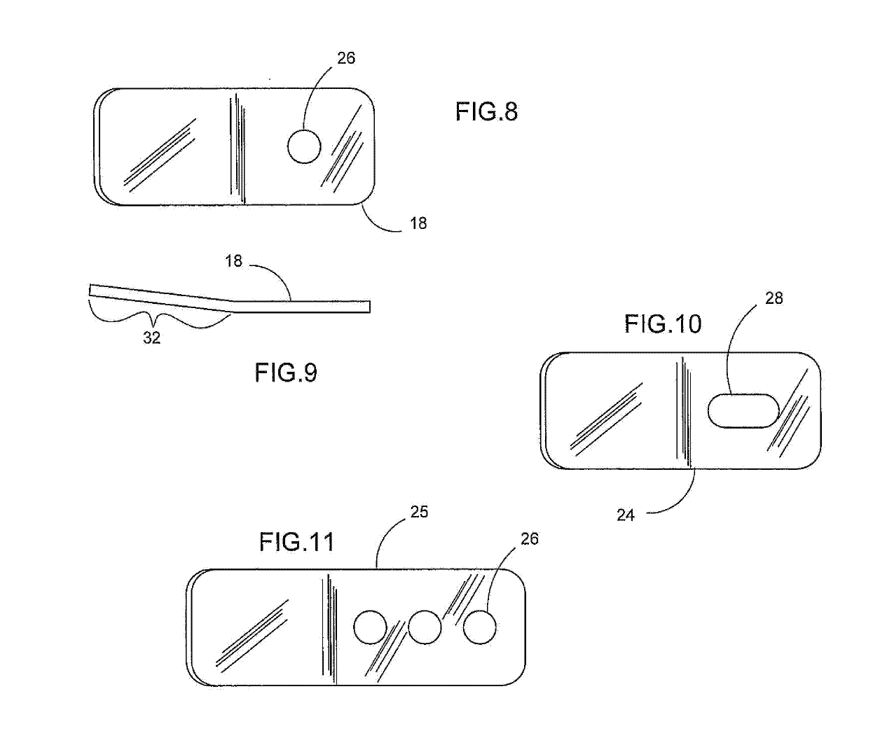

FIG. 9 is a side view of a securing plate according to one embodiment of the present invention.

FIG. 10 is a securing plate with an incorporated slot according to one embodiment of the present invention.

FIG. 11 is a securing plate with multiple mounting holes according to one embodiment of the present invention.

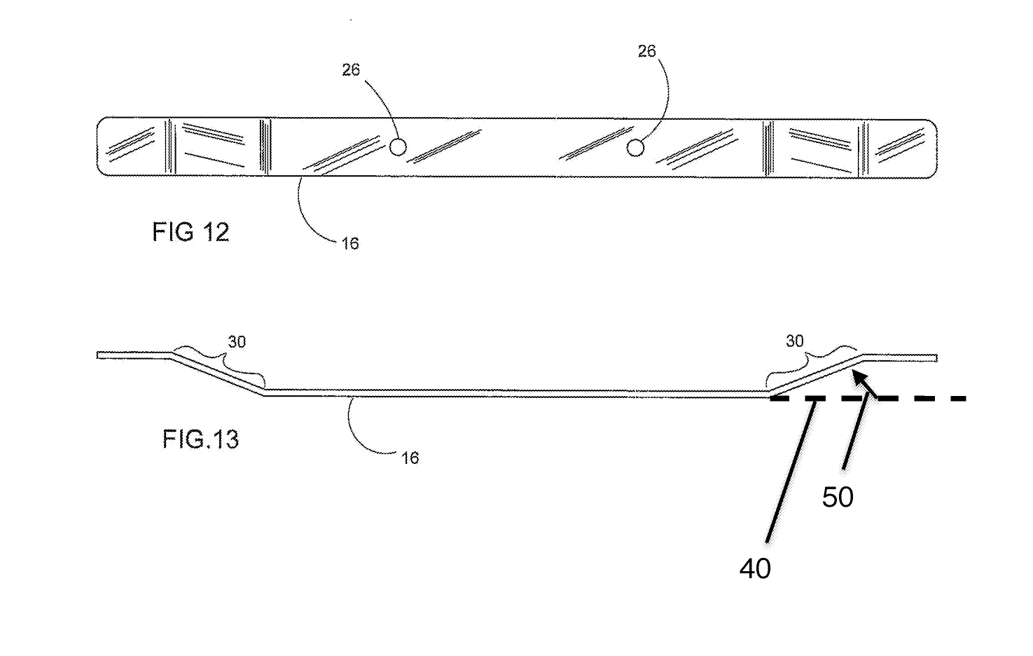

FIG. 12 is a top view of a mounting bracket according to one embodiment of the present invention.

FIG. 13 is a side view of a mounting brackets according to one embodiment of the present invention.

### DETAILED DESCRIPTION OF THE PREFERRED EMBODIMENT

As generally understood, the present invention includes a main body configuration with a locking tab and bolt. As demonstrated in the figures, a user will select a desired tab as well as a user-selected hole in which to fasten.

While there are many storage devices and systems available to the public, there is no such system that secures with the simplicity and ease as the present invention.

In one embodiment, the present invention is configured such that a user utilizes I-beams as shelving, hooks, or holdings for a multitude of storage items.

Although the figures demonstrate utilization with I-beam, the present invention contemplates configurations utilizing a plurality of hanging systems.

System 10 is a material storage bracket system. In one embodiment, I-beam 12 has bracket 14 attached. Bracket 14 is constructed and arranged with an attaching first and 32 that is shaped and configured in a general U-shaped configuration for attaching onto I've been 12. Bracket 14 is further configured with a second and having retainment section 30 that is angled for the function of retaining stored items onto bracket 14. As generally understood and demonstrated by figure to securing plate 18 is fastened utilizing securing bolt 20 and securing nut 22 which ultimately secures bracket 14 into a fixed position.

As demonstrated in FIGS. 8 through 11 the securing plate of the present mentioned is contemplated as having various configurations. Securing plate 18 has a single bolt hole 26 configured for receiving a single bolt there in securing plates 25 has a plurality of bolt holes 26 as demonstrated in FIG. 11. Security plate 24 as a central slot 28 for receiving a securing means therethrough.

System 10c of FIG. 4 demonstrates placement of Storage material 34 in a system of the present invention.

In one embodiment of the present invention, as demonstrated by System 10b of FIG. 5, a dual bracket System is utilized.

As demonstrated in and 13, a dual bracket 16 configuration is further contemplated in the present invention. Reference line 40 used demonstrate an angular offset represented by offset arrow 50 whereby an angle measuring 10-30 degrees is formed from reference line 40 and retainment section 30. As in FIG. 13, one embodiment provides two retainment sections each with angular offset 10-30 degrees. The embodiments include retainment offsets that are equal and embodiments where retainment offsets are different but still between 10-30 degrees.

In use, a bracket of the present invention is secured as shown and described in the figures. Although the figures demonstrate I-beam, it is contemplated configurations utilizing other overhead exposed beam structures are utilizing the present invention.

A user will secure a brackets and position Storage articles thereupon. The retainment section 30 is configured to prevent storage article from sliding off the bracket.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A storage system comprising:
a main support bracket, said bracket constructed and arranged to connect and mate directly to a beam;
a securing plate having one or more fastening cavities; and
a locking bolt.

2. The system of claim 1 wherein said support bracket has u-shaped first mounting end constructed to mate with an I-beam.

3. The system of claim 1 wherein said support bracket is constructed to receive and connect with said securing plate.

4. The system of claim 1 utilizing a single support bracket.

5. The system of claim 1 utilizing two support brackets imparting a linear configuration.

6. The system of claim 1 wherein said support bracket has a second end configured with a retainment section adjacent to said second end.

7. The system of claim 1 wherein said support bracket has a second end configured with a retainment section adjacent to said second end said retainment section configured with an upward angle of 10-30 degrees relative to a horizontal created by support bracket.
